(19) United States
(12) Patent Application Publication
(10) Pub. No.: US 2024/0408691 A1
(43) Pub. Date: Dec. 12, 2024

(54) High Frequency Power Supply System with Closely Regulated and Monitored Output for Heating a Workpiece and Providing Process Feedback

(71) Applicant: Thermatool Corp., East Haven, CT (US)

(72) Inventors: Elik Dvorkin, Woodbridge, CT (US); Victor Kuc, New Haven, CT (US); Victor H. Monreale, Hamden, CT (US)

(21) Appl. No.: 18/735,747

(22) Filed: Jun. 6, 2024

Related U.S. Application Data
(60) Provisional application No. 63/471,530, filed on Jun. 7, 2023.

(51) Int. Cl. B23K 13/08; B23K 13/01; H02M 7/539

(52) U.S. Cl. CPC B23K 13/08; B23K 13/01; H02M 7/539

(57) ABSTRACT

A high frequency power supply system provides highly regulated power and frequency to a workpiece load where the highly regulated power and frequency can be independent of the workpiece load characteristics by inverter switching control and an inverter output impedance adjusting and frequency control network that includes precision variable reactors. Furthermore, a software system employs knowledge of the variable reactor properties to determine the effective load impedance. This information can be provided to the plant staff in real time, via alarms or via trending information to provide information about the load independent of any automatic compensation performed by the inverter output impedance adjusting and frequency control network. This information may be sent to a cloud-connected computer for one or more of storage, display, further processing, or to send notifications.

### CROSS-REFERENCE TO RELATED APPLICATIONS

This application claims priority to U.S. Provisional Application No. 63/471,530 filed Jun. 7, 2023, hereby incorporated by reference in its entirety.

### FIELD OF THE INVENTION

The present invention relates to high frequency induction heating power supplies, and more particularly relates to a high frequency induction heating power supply implementing load matching control systems with process feedback and predictive capabilities.

### BACKGROUND OF THE INVENTION

Induction welding is a form of welding that uses electromagnetic induction to heat a portion or portions of a metal part or parts as the portion or the portions of the metal part or parts are advanced. The heated portion or portions, for example, the opposing edges of a metal sheet are welded together by applying a force between the inductively heated portion or portions, for example, to form a tubular product in an ambient atmosphere or a controlled environment such as an inert gas or vacuum.

One example of an industrial induction welding process is forge welding of a tubular article of manufacture from a processed material such as sheet 104 (workpiece) that is at least partially electrically conductive as graphically illustrated in FIG. 1. In this process, the opposing edges 104a and 104b of sheet 104 are inductively heated by the magnetic field established by high frequency alternating current flow through induction coil 106 supplied from a high frequency power supply system not shown in the figure. The inductively heated opposing edges are rolled (forged) together with tooling rolls 108a and 108b to form the tubular article 110 and a weld heat affected zone (HAZ) 113 as sheet 104 moves from right to left in the figure as indicated by the arrows. The induction coil and the magnetically coupled workpiece weld region, along with impedance adjusting devices such as an impeder 112 inserted within the rolled weld region form a weld electric load (workpiece) circuit with dynamically changing load characteristics during the welding process.

Electric resistance welding (ERW) is a form of welding that uses resistance heating to heat a portion or portions of a metal part or parts as the portion or the portions of the metal part are advanced. The heated surfaces are welded together by applying a force between the resistively heated portion or portions, for example, the opposing edges of a metal sheet, in an ambient atmosphere or a controlled environment such as an inert gas or vacuum to form a tubular product.

One of the challenges of operating a high frequency induction welding process is the variability of the impedance of the load. Because the load is part of the resonant circuit which determines the frequency of operation and the ability of the power supply to deliver power, it is imperative that the load impedance be held constant during operation. In a tube mill, the frequency of operation is a critical parameter which sets the heat-affected-zone due to varying reference depth. A variety of factors can cause the load impedance to change, including improper coil selection, improper coil installation, partial or gradual failure of the impeder, changes in the geometry of the workpiece along with other factors. For example, as the impeder begins to fail, less of the magnetic flux is directed towards the opposing edges of the workpiece and instead causes undesired circulating currents in other parts of the workpiece, resulting in lower weld temperatures in the HAZ. While undesirable, these changes occur with some regularity in the day-to-day operation of tube mills whether due to equipment wear or changes made when setting up a manufacturing line to make a different product.

Several approaches to compensating for these changes to ensure consistent process control and to eliminate plant shutdowns related to inability to deliver sufficient power or appropriate frequency have been developed. For example, U.S. Pat. No. 10,405,378 (the '378 patent), which is incorporated herein by reference in its entirety, discloses a high frequency electrical heating system for electrically conductive parts as they are advanced utilizing a load matching and frequency control circuit to maintain a desired load current and frequency with changes in load impedance via high frequency variable reactors. The variable reactors comprise geometrically shaped movable insert core sections and a stationary split-bus section with a complementary geometrically shaped split-bus section and a split electric terminal bus section where the movable insert core section can be moved relative to the stationary split-bus section to vary the reactance of the reactor pair.

Alternatively, U.S. Pat. No. 10,855,194 (the '194 patent), which is incorporated herein by reference in its entirety, discloses a high frequency electrical heating system utilizing precision variable reactors similar to that disclosed in the '378 patent, but further comprising an inverter switching control and an inverter output impedance adjusting and frequency control network that can isolate the highly regulated power and frequency from the workpiece load characteristics.

Shown in FIGS. 2 and 3 are examples of a high frequency power supply having a closely regulated output for heating a workpiece load 30 in a welding or annealing process of the incorporated prior art. Rectifier 11 converts three-phase alternating current to direct current and is connected to an inverter 31 having a plurality of transistors 12, 13, 14, and 15 through leads 16 and 17 and fixed inductor 18. The plurality of transistors 12, 13, 14, and 15 may be metal-oxide-semiconductor field-effect transistors or other suitable solid state switching devices. Rectifier 11 can further have a DC control 32 for controlling the DC voltage output of rectifier 11. Current sensor 19 provides an output to current comparer 33, and the output of current comparer 33 is supplied to DC control 32 to ensure that the maximum current level is not exceeded.

The output of current sensor 19 and the output of voltage and frequency sensor 34 (shown diagrammatically and selected to provide information as to the voltage and frequency of the power at the leads 21 and 22) are supplied to comparer 35 which compares the measured voltage, current and frequency with predetermined values of voltage, current and frequency and acts as a load matching control for maintaining the desired load impedance and inverter frequency at the output of the inverter 31. Comparer 35 provides an electrical output which powers an actuator, for example, motor M2 for varying the reactance control element (motion stage) for parallel reactor pair 25-25′, an electrical output which powers an actuator, for example, motor M1, for varying the reactance control for series variable capacitor pair 26-26′, and an electrical output which powers an actuator, for example, motor M3, for varying the reactance control for series variable reactor pair 24-24′.

A system microprocessor controller variably controls the adjustable capacitive and inductive elements (variable impedance elements). In such embodiments, system microprocessor control elements of the adjustable reactors and/or capacitors in the inverter output impedance adjusting and frequency control network, including the high frequency controller 38, current comparer 33, and the voltage, current, and frequency comparer 35, are used to compensate for changes in characteristics of load 30 so that a resonant point can be maintained regardless of a change in load characteristics. For example, if inductance at the load increases, the inductance in the inverter output impedance adjusting and frequency control network can be decreased so that overall equivalent system inductance is maintained, which results in the same resonant point regardless of the change in load characteristics. Further, if the Q (quality) factor of the load is decreased, the Q factor in the inverter output impedance adjusting and frequency control network can also be decreased through the system microprocessor controller of the variable capacitance and inductance which results in an equivalent resonant point of power transfer with the characteristics of the high frequency power supply system matching the load characteristics.

As shown in FIG. 4(a) through 4(c), one exemplary variable reactor of the incorporated prior art comprises a reactor pair having a single short circuited geometrically shaped insert core section 62 configured to move in or out of complementary geometrically shaped split bus conic sections 64a and 64b of a stationary split-bus section 64 via motor M′. The magnitude of induced current in the insert core section 62 establishes a variable magnetic flux field (also referred to as the variable energy field) from alternating current flow in the complementary geometrically shaped split bus conic sections 64a and 64b to establish a variable inductance at split electric bus terminal sections A1-B1 and A2-B2 of the alternating current buses. The pair of reactors can have a range of variable inductance from a minimum inductance value when the geometrically-shaped insert core section 62 is fully inserted into the complementary geometrically-shaped split conic bus sections 64a and 64b to a maximum inductance value when the geometrically-shaped insert core section 62 is withdrawn to a position, such as when the variable energy field in the shaped interleaving space between the insert core section 62 and stationary split-bus section 64 is at a maximum value, as shown in FIG. 4(b). FIG. 4(c) illustrates the variable reactor pair 60 connected in the high frequency power supply system of FIG. 2 as variable reactor pair 24a-24a′. Stationary split bus section 64 comprises electrically isolated and spatially separated split conic bus sections 64a and 64b and split electric bus terminal sections A2 and B2 (associated with conic bus section 64a) and split electric bus terminal sections A1 and B1 (associated with conic bus section 64b).

Alternatively, FIG. 5 illustrates another example of a high frequency variable reactor 90 of the incorporated prior art comprising a single short-circuited insert core section 92 in the geometric shape of a polyhedron defined by two triangles and three trapezoid faces, which is identified as a wedge section. The insert core section 92 is moved in or out of the stationary complementary shaped split wedge bus sections 94a and 94b of stationary split-bus section 94 via motor M′. The magnitude of induced current in the insert core section 92 establishes a variable magnetic flux field from alternating current flow in the complementary geometrically shaped split wedge bus sections 94a and 94b to establish a variable inductance at split electric bus terminal sections A1-B1 and A2-B2 of the alternating current buses. The pair of reactors can have a range of variable inductance from a minimum inductance value when the geometrically-shaped insert core section 92 is fully inserted into the complementary geometrically-shaped split wedge bus sections 94a and 94b to a maximum inductance value when the geometrically-shaped insert core section 92 is withdrawn to a position, such as when the variable energy field in the shaped interleaving space between the insert core section 92 and stationary split-bus section 94 is at a maximum value. Variable reactor pair 90 is connected in the high frequency power supply system of FIG. 2 as variable reactor pair 24a-24a′. Stationary split bus section 94 comprises electrically isolated and spatially separated split wedge bus sections 94a and 94b and split electric bus terminal sections A2 and B2 (associated with conic bus section 94a) and split electric bus terminal sections A1 and B1 (associated with conic bus section 94b).

However, while these approaches allow for the system to automatically compensate, they do not provide feedback to the user or to plant management that their load has drifted from its nominal configuration. This can lead to an eventual shutdown caused by the load finally drifting out of the acceptable range, which the prior art load matching systems compensate for automatically without any warning being provided. As such, preventative measures, or other proper planning to prepare for the eventual required maintenance cannot be taken to minimize any downtime in the tube mill when the load drifts outside of the acceptable load impedance variance range.

Therefore, there is a need for an automatically compensated high frequency power supply that provides process feedback to alert the user of impedance load drift from nominal values.

### BRIEF SUMMARY OF THE INVENTION

The process of tube manufacturing by ERW welding commonly makes use of a ferritic rod (impeder) placed near the forge point of the tube which helps to localize heating to the strip edges rather than unproductively heat the bulk of the tube. This component is critical to successful welding, but it has a finite lifetime. As this device fails, the load inductance changes and the quality of the weld decreases. Prior art devices fail to provide a means to determine the degradation of this component. Additionally, the cited prior art devices indirectly obfuscate the gradual failure of the impeder, as the cited load matching control systems automatically correct for gradual impedance changes caused by the gradual failure of the impeder. This can produce false diagnostic results, leading system operators to be unaware of impeder degradation until it exceeds a maximum operational range that the load matching control system can tolerate.

Furthermore, there are other aspects of the mill setup that affect impedance. There is a desire within the operators and managers of these facilities to have further insight into these process shifts to reduce defect rates, improve uptime, and improve the supervision of employees performing mill setup.

The present invention provides a system for providing feedback to the plant staff of a shift in the impedance of the load, which is comprised of the coil and workpiece, even if the automatically controlled variable reactors have already compensated for this shift. In the case of a continuously changing parameter, such as an impeder beginning to fail, a measurement indicating a trend away from nominal impedance can serve as a predictive warning that a worsening situation may lead to a line stoppage in the future.

The above and other aspects of the invention are set forth in this specification and the appended claims.

### BRIEF DESCRIPTION OF THE DRAWINGS

The appended drawings, as briefly summarized below, are provided for exemplary understanding of the invention, and do not limit the invention as further set forth in this specification and the appended claims.

FIG. 1 shows a graphical illustration of a forge welding power supply output load circuit of the prior art comprising an induction coil and the opposing edge portions of a metal sheet being folded to form a tubular article of manufacture in a forge welding process.

FIG. 2 shows one example of a simplified control diagram of a control system for a high frequency heating power supply system of the prior art.

FIG. 3 shows one example of a simplified diagram of a high frequency heating power supply system of the prior art utilizing a current source inverter.

FIG. 4(a) shows one example of a variable reactor for a high frequency heating power supply system of the prior art.

FIG. 4(b) shows an alternate example of a variable reactor for a high frequency heating power supply system of the prior art.

FIG. 4(c) shows an example of the impedance adjusting and frequency control network of FIG. 2 showing where the pair of variable reactors in FIG. 4(a) and FIG. 4(b) can be used for reactor pair 24a-24a′ in FIG. 2.

FIG. 5 shows an example of a wedge-shaped variable reactor for a high frequency heating power supply system of the prior art.

FIG. 6 shows one example of a simplified control diagram of a control system for a high frequency heating power supply system having monitored outputs to provide process feedback of the present invention.

FIG. 7 shows a simplified control diagram for a system which implements the software elements of the invention.

FIG. 8 shows one example of a previously measured curve relating variable reactor position to reactor inductance.

FIG. 9 shows one example of a system diagram of the power supply system with process feedback showing cloud connectivity, a web interface and trending information.

FIG. 10 shows one example of the system diagram of FIG. 9 including asynchronous monitoring of trending information.

FIG. 11(a) shows a front plan view of one example of the high frequency welding system implementing the control system.

FIG. 11(b) shows a top plan view of the high frequency welding system of FIG. 11(a).

FIG. 12(a) shows a flow diagram of an example of the control system implemented by the high frequency power supply system.

FIG. 12(b) shows a flow diagram of an alternate example of the control system implemented by the high frequency power supply system including cloud data storage.

FIG. 12(c) shows a flow diagram of an alternate example of the control system implemented by the high frequency power supply system to compensate for deviation from an expected workpiece load value.

FIG. 12(d) shows a flow diagram of an alternate example of the control system implemented by the high frequency power supply system to diagnose and provide an alert of the rate deviation from an expected workpiece load value.

FIG. 13(a) shows one example of the graphical user interface indicating the selectable limits of operational load inductance.

FIG. 13(b) shows a graph of normalized load inductance over time illustrating selectable limits about the normalized inductance value.

### DETAILED DESCRIPTION OF THE INVENTION

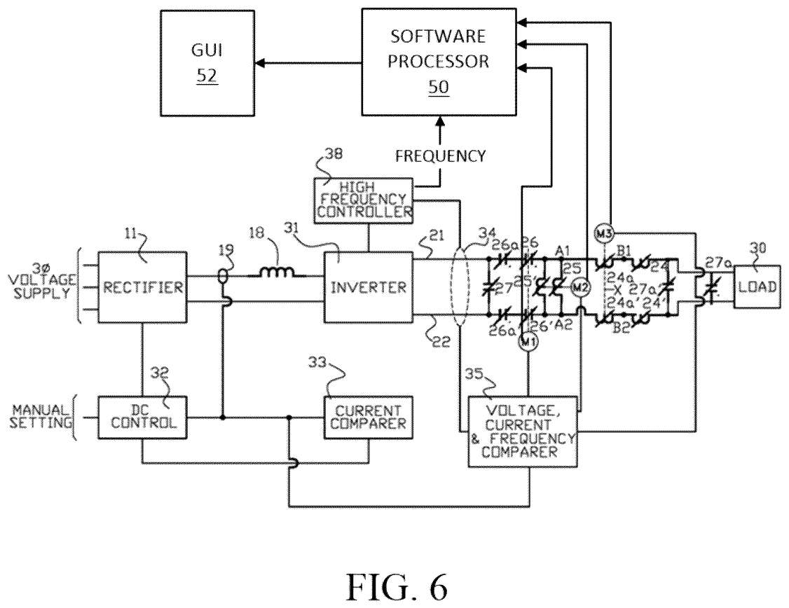

Referring now to the drawings, wherein like numerals indicate like elements there is shown in FIG. 6, in accordance with the present invention, one example of a high frequency heating power supply system having monitored outputs to provide process feedback. Throughout the following disclosure, one or more variable reactors are discussed in various configurations, for example, pairs of variable reactors in both series and parallel, however the circuit topology of the inverter output impedance adjusting and frequency control network of the present invention is contemplated to include additional configurations of variable reactors, either in series or in parallel as suits a particular application. It should be understood that the following methodology may be used for any circuit topology, however the equations required to determine load inductance will change as further discussed elsewhere herein. Furthermore, the variable reactors discussed herein are contemplated to comprise variable inductors, variable capacitors, or a combination thereof as best suits the particular application.

The system described in this invention takes advantage of variable reactor position information and a previously measured reactance and position relationship as a highly sensitive measurement instrument for measuring the welder load. To determine the load, the total impedance of all of the variable reactors can be mathematically determined from the operating frequency, which is always held at the resonant frequency by the phase-locked loop (PLL) formed by the circuit diagram of FIG. 6, and the value of the resonant capacitors. From there, circuit analysis techniques can be used to deduce the load impedance from the variable reactor impedances which can be predicted from a previously measured curve and the variable reactor positions.

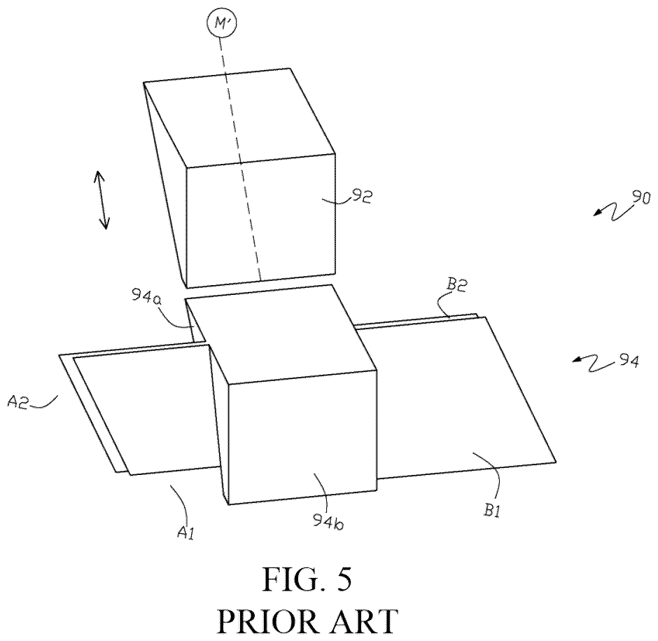

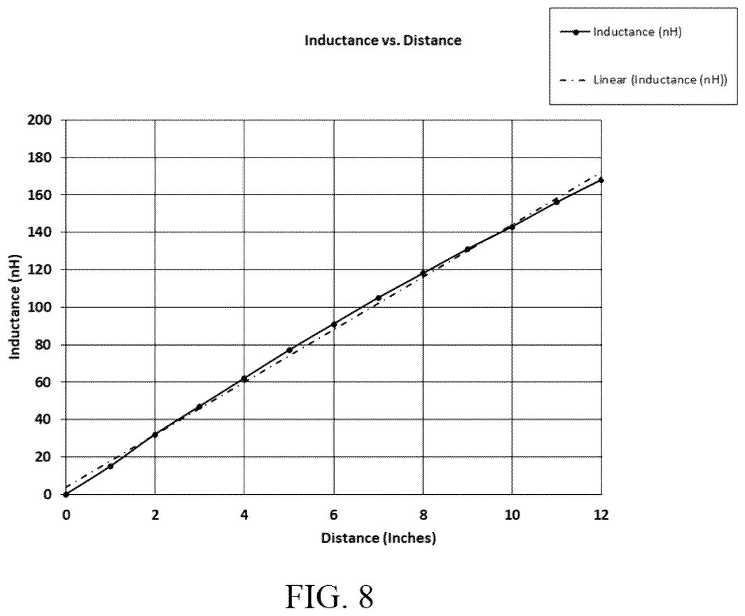

Referring to FIG. 8, the relationship between the variable reactor position and reactor inductance is shown for an exemplary variable reactor geometry, particularly the wedge-shaped variable reactor geometry disclosed in the '378 patent, incorporated herein by reference in its entirety and best illustrated in FIG. 5. The wedge-shaped variable reactor geometry includes a polyhedral moveable insert core 92 defined by a pair of triangular faces and three trapezoidal faces, wherein the moveable insert core 92 (motion stage) is selectively moveable within a stationary split bus construction 94 having a complementary shape to the movable insert core 92 to adjust an impedance of the variable reactor. The inductance produced by such variable reactors ranges from a minimum when the movable insert core 92 is fully inserted within the complementary split bus sections 94a and 94b to a maximum when the movable insert core 92 is removed from within the complementary split bus sections 94a and 94b. As illustrated in the graph of FIG. 8, the x-axis represents relative position of the movable insert core 92 with respect to the complementary shaped reactor split bus sections 94a and 94b, for example, the distance between the moveable insert core 92 and a top of the complementary split bus sections 94a and 94b, and the y-axis represents the inductance in nanohenries. As the movable insert core 92 is inserted within the complementary split bus sections 94a and 94b, the inductance decreases. As shown in FIG. 8, once the measured data has been plotted, a curve fit can be applied to approximate a continuous function for load impedance analysis purposes. For example, in the illustrated embodiment, the inductance curve has been modeled with a linear regression. As such, knowing the moveable insert core position, the previously measured impedance for that moveable insert core position can be utilized to deduce the load impedance. In other embodiments, the previously measured curve fit can comprise a higher order function such that impedance varies relative to reactor position in a non-linear manner. In another embodiment, the previously measured data comprises a lookup table of values rather than a modeled continuous function.

In one aspect, as shown in FIG. 6, the present invention comprises a graphical display or a graphical user interface (GUI) 52, a software processor running an algorithm 50, a welding power supply comprised of a full bridge or half-bridge inverter 31, a resonant circuit including a load 30, and one or more variable reactors (24, 24′, 24a, 24a′, 25, 25′, 26, 26′, 26a, 26a′), each reactor actuated by a motor (M1, M2, M3) with position feedback. As shown in FIG. 6, the rectifier 11 converts three phase alternating current to direct current and is connected to an inverter circuit comprising transistors through fixed inductor 18. Current sensor 19 provides an output proportional to the current supplied to the inverter and hence, to load 30. When a high frequency power supply heating system is used, for example in an induction welding or annealing application or electric resistance welding application, load 30 includes electrical leads and an induction coil or electric contacts (contacting the portion or portions) to be welded, annealed, or otherwise heated. The solid state inverter 31 in FIG. 6 has a first single phase inverter output terminal or lead 21 and a second single phase inverter output terminal or lead 22 feeding impedance elements in the inverter output impedance adjusting and frequency control network 23.

In the shown embodiment, the inverter output impedance adjusting and frequency control network comprises a combination of a first pair of series variable reactors 24 and 24′, a second pair of series variable reactors 24a and 24a′, a first pair of series variable capacitors 26 and 26′, and a second pair of series variable capacitors 26a and 26a′ as arranged and interconnected in the figure. The network further comprises a combination of a pair of parallel variable reactors 25 and 25′ and a pair of parallel variable capacitors 27a-27a′ arranged and connected in parallel between the single-phase inverter output leads as arranged and interconnected in the figure, and a further parallel variable capacitor 27 arranged and connected in parallel between the single phase inverter output leads as shown in the figure.

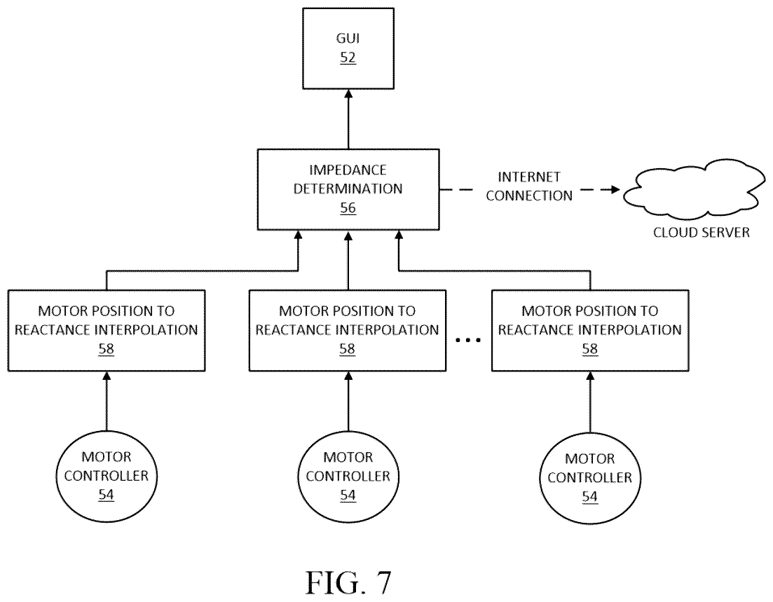

As illustrated in FIG. 7, each variable reactor includes a motor controller 54 configured to selectively move at least one motion stage of the variable reactor relative to a stationary portion of the variable reactor to adjust the effective impedance of the variable reactor. The motor controller 54 further comprises position feedback elements that communicate the position of each motion stage of each variable reactor relative to each stationary portion of the variable reactor to a software processor executing the software program configured to determine the load impedance 56 based on variable reactor motion stage positions and associated interpolated reactances 58 for those motion stage positions, as well as the operating frequency reported by the high-frequency controller 38 as further described below. The determined load impedance can then be communicated to the GUI 52 and optionally to a remote or cloud-based storage location via internet connection.

The GUI 52 displays the load impedance, a simplified measure of the load impedance, or a measurement of the deviation in load impedance from a nominal value. One way to simplify the impedance value, which may not be intuitive to the user, is to normalize the impedance measurement versus the previously established nominal measurement. The value to be shown is determined by the algorithm run by the software processor 50 in the following manner. As shown in FIG. 7, the software performing the impedance calculation 56 has access to measurements of the operating frequency of the system (guaranteed by the PLL to be the resonant frequency), the fixed reactances in the unit, the positions of the motion stages of the variable reactors of the system as reported by the motor controllers 54, and the determined reactances 58 based on interpolated values based upon the position of the motion stages of the variable reactors from a look up table. Instead of a look up table, it is instead possible to fit an equation to the previously measured values of position (either rotational or linear depending on the geometry of the variable reactor) and its impedance. This equation can be linear, polynomial or another type.

Knowing these parameters, if for the sake of analysis, the system can be reduced to a second-order parallel or series LC circuit, then it is known that the frequency of operation is related to the LC elements by the following equation:

$$f = \frac{1}{2 π \sqrt{LC}}$$

where L is the total effective inductance and C is the total effective capacitance which can be combined for analysis by means of parallel or series combinations. This equation can be solved for a single unknown reactance, in our present case, the inductance of the load. This resultant equation can be used to compute the load inductance given known reactances and the frequency of operation.

More generically, it is possible to have a system where the inductances and capacitances do not form a second order parallel or series LC circuit. In this case, there still exists a relationship between resonant frequency and the various impedances in the circuit. Circuit analysis techniques can be used to create an equation for the input impedance of the circuit comprised of all discrete impedances in the circuit and solving for the frequency at which the input impedance is highest or when the circulating current in the load is highest. Using the resultant equation, the load inductance at the given frequency and with the real-time reactance values can be determined. In an exemplary embodiment, the load inductance is within a range of 100 to 400 nanohenries.

In one embodiment, the user saves the load impedance within the GUI 52 when the power supply is operating with a proper load configuration. The GUI 52 may display a gauge indicating extremes of impedance outside of the nominal load impedance. Any deviation in impedance, regardless of reactor position changes to compensate, can be determined with the aforementioned technique to display the change in load impedance. In this manner, the operator is readily informed of any load impedance corrections that have been made during operation. Furthermore, trending this value over time can indicate drift of the load characteristic alerting the operator of potential maintenance requirements or other impending line shutdowns. The software performing the impedance determinations may further extrapolate a length of time before the impedance drifts beyond a nominal or actionable state.

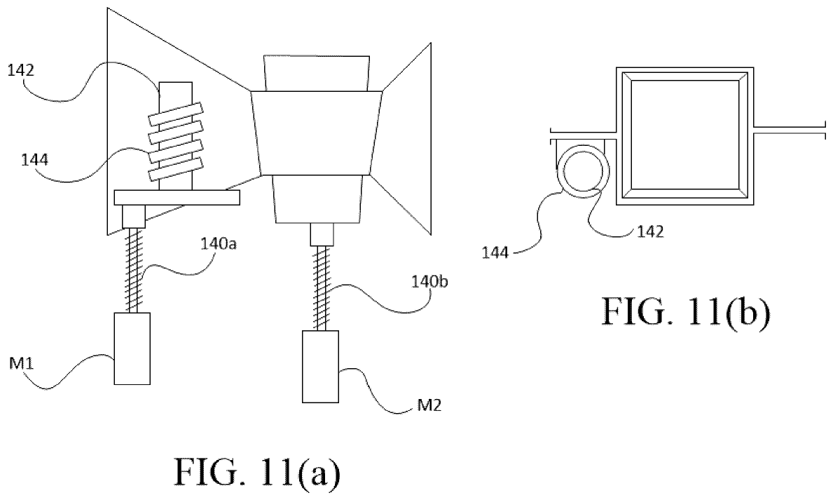

As illustrated in FIG. 11(a) and FIG. 11(b), there is shown an exemplary implementation of the present invention, specifically a high frequency welding apparatus having one or more variable reactors selectively movable via an associated motors M1 and M2. Each motor M1, M2 comprises a motor controller having position feedback sensors operably affixed to a lead screw 140a and 140b configured to selectively move an associated variable reactor insert core positioned on a motion platform relative to a stationary portion of the variable reactor. The welding apparatus may further include motion platforms affixed to one of a movable ferrite core (impeder) 142, or a moveable induction coil. In the illustrated embodiment, motor M1 is operably affixed to lead screw 140a and is configured to move ferrite core 142 through stationary induction coil 144. Additionally, a movable insert core similar to the embodiment shown in FIG. 5 is operably connected to motor M2 via lead screw 140b. In this manner, the movable insert core and the ferrite core 142 can be selectively positioned to adjust the impedance of the high frequency welding apparatus to compensate for variations in workpiece load inductance over the course of a production run.

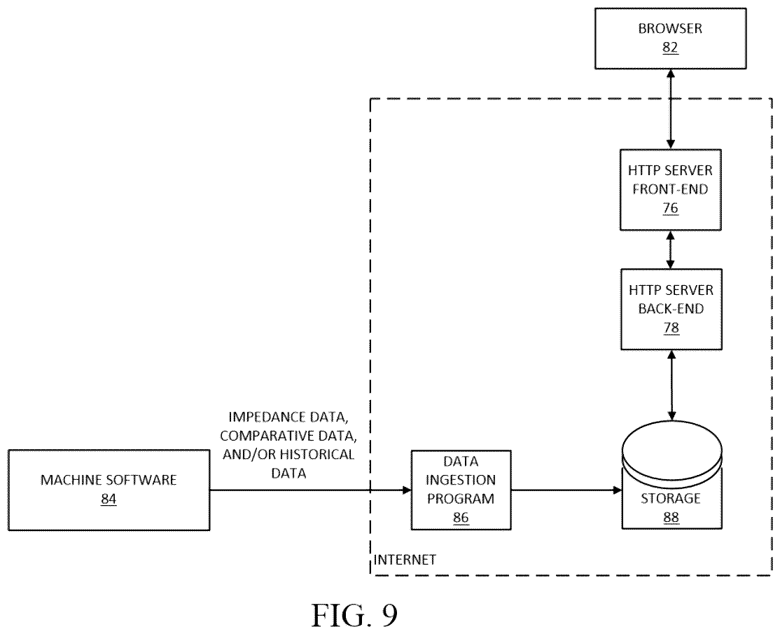

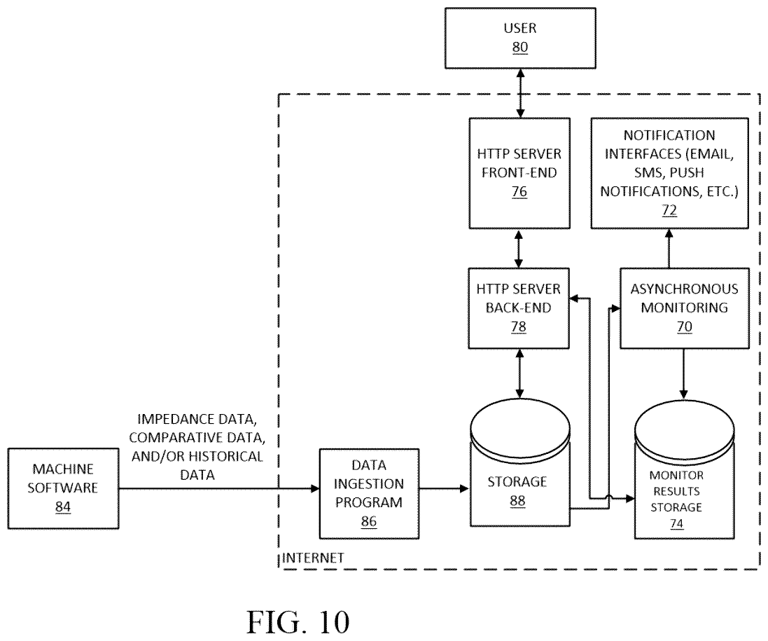

As illustrated in FIG. 9 and FIG. 10, the machine software 84 performing the above-described determinations and interpolations can communicate the associated data to a remote or cloud-based storage and notification system via the internet. In the shown embodiments, each of impedance data, historical impedance data, and comparative data may be transmitted to a data ingestion program 86 configured to collect, sort, compile, and store the collected data within non-transitory computer readable memory storage 88. The stored data can then be accessible to a user 80 via an online platform (shown generally as an HTTP server architecture having a front-end 76 and a back-end 78) accessible from a browser 82. As shown in FIG. 10, the system may further include asynchronous monitoring 70 of the data stored within the non-transitory computer readable memory storage 88. The asynchronous monitoring 70 comprises monitoring software configured to trend deviations in system impedance over time to provide user notifications 72 of non-transient drift conditions that must be addressed. The trend data is then stored in a monitor results storage 74 and is accessible by the HTTP server back-end 78 to be displayed by the HTTP server front-end 76. In some embodiments, the asynchronous monitoring 70 utilizes a neural network or other intelligent network trained to provide feedback on the collected data based on pattern recognition, trending values over time, absolute values, or a combination thereof to predict actionable equipment maintenance requirements or contextualize data trends to diagnose a particular equipment issue.

Further variations include the addition of textual guidance for the facility staff which may be based on whether there is an increase or decrease in impedance. For example, if the determined impedance registers over the nominal impedance value, the GUI 52 can return guidance instructing the operator that the associated coil is too large, or that the connection to the coil is too long, such that the process is informed how to potentially remedy the impedance drift. Alternatively, if the determined impedance is too low, the GUI 52 can return guidance instructing the operator that the ferrite impeder failed. In this manner, the operator can troubleshoot the potential error before the impedance drift becomes substantial enough to require shutdown of the equipment for correction.

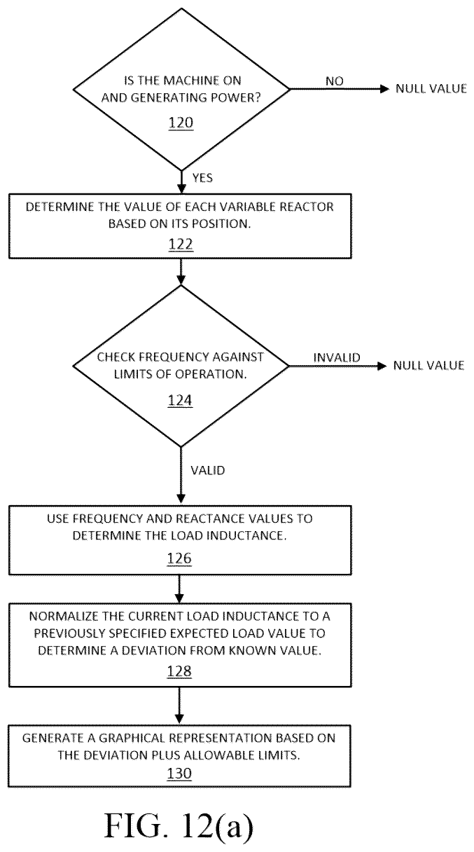

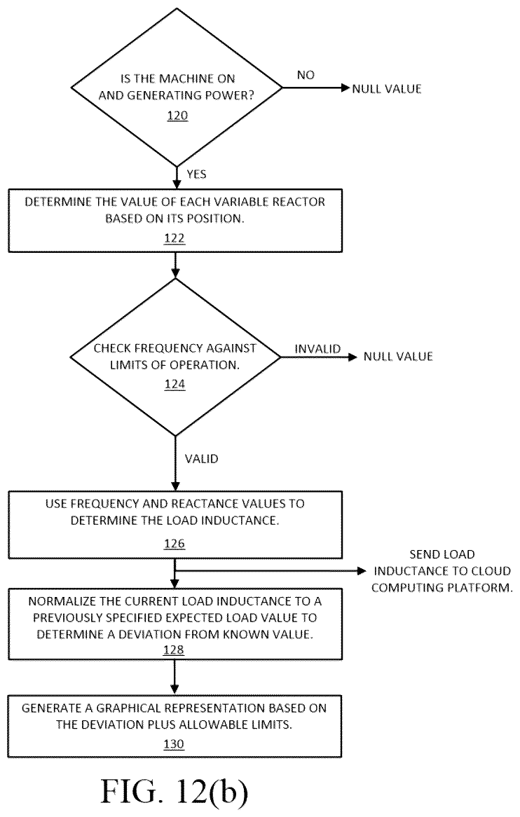

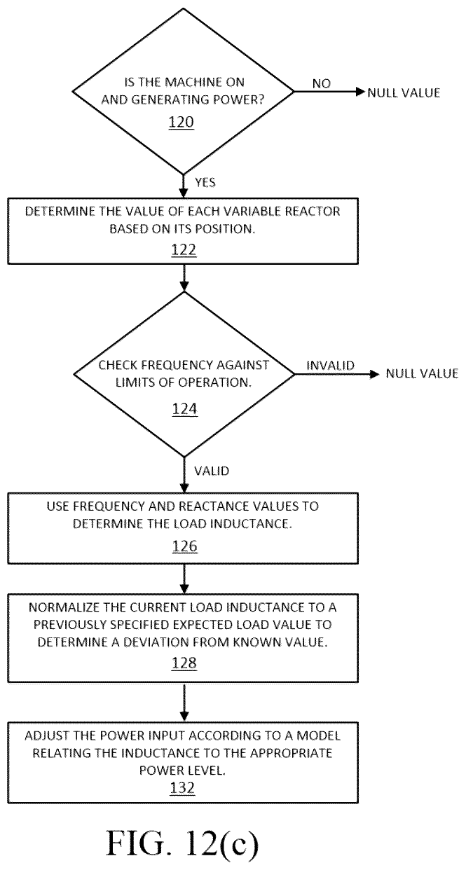

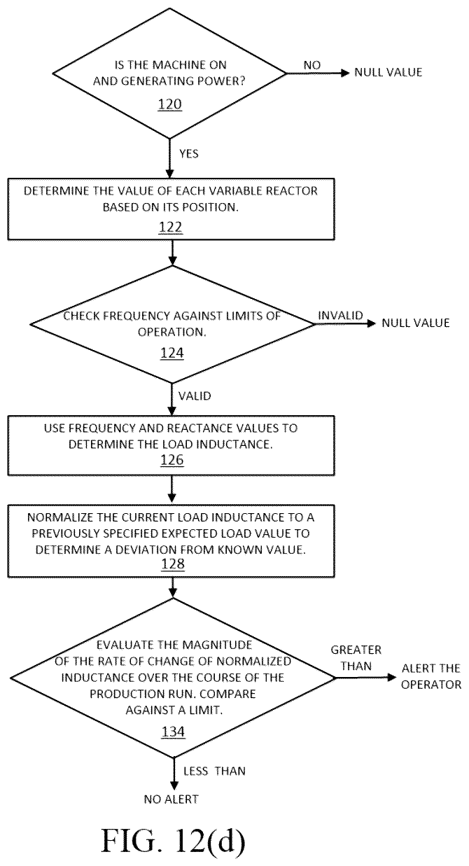

As illustrated in FIG. 12(a), an exemplary embodiment of the algorithm implemented by the control system is shown. The algorithm may be implemented continuously or periodically, whereupon adjustments to the motion stage of the variable reactors initiate the algorithm. Initially, a user selects a workpiece or weld setup recipe which includes expected operational parameters, including expected workpiece load inductance. This workpiece recipe may be initially generated by operating the desired process with a verified coil and impeder configuration until a steady state is reached, at which point the current operating parameters may be saved as a baseline expected workpiece load for selection in future operations. The control system initially determines whether the high frequency power supply system is active and generating power 120 and returns a null value if the power supply is inactive. Upon receipt of a null value, the algorithm identifies that a valid load measurement is not available. This does not necessarily need to affect machine operation, except to prevent saving invalid data. The algorithm effectively repeats until a null value is not received, at which point the following steps in the process proceed. The reactance value of each variable reactor is then determined based on the position of the motion stage of the variable reactor as reported by the position feedback of the motors 122. This value can be determined based on previously recorded empirical data identifying nominal reactance of the variable reactor relative to motion stage position as previously discussed, or alternatively through interpolation determined through applying a curve fit to a range of reactances relative to position data. The reactance may further be determined based on electromagnetic modeling of the system, including the position of the motion stage relative to the stationary variable reactor element, the characteristics of the workpiece load, and the circuit topography. In this manner, analytical, empirical, and predictive data may be utilized to determine the effective reactance for a given relative distance measurement. The frequency is maintained at a resonant frequency of the circuit as a result of the PLL, however if the resonant frequency is determined to be outside of predefined limits of operation 124, for example, during startup as, the provided power is unable to produce the resonant frequency until the provided power ramps up, or other transient behavior, a null value is returned, and as such the algorithm halts and repeats this step until a null value is not returned. In this manner, invalid data during these transient operating conditions is not displayed, saved or stored, so as not to capture irrelevant load inductance values.

From the reactance value of each variable reactor and the frequency of the power supplied, a current load inductance (present or instant load inductance) is determined through determinations associated with the circuit topology 126 as previously discussed. In the embodiment illustrated in FIG. 12(b), the determined current load inductance can optionally be transferred to a remote storage or cloud computing platform for further analysis or storage. The current load inductance is then normalized to a previously specified expected load inductance value to define a deviation from the expected load inductance value 128. The previously specified expected load inductance can be initially registered with the control system via a teach function, wherein the expected load inductance corresponds to prior tabulated load inductances for similar workpieces in similar operating conditions. Alternatively, the initially registered expected load inductance can be representative of nominal operating conditions for a current production run operating within expected values of inductance. For example, upon actuating a teach control on the GUI, the current load inductance value is registered as the nominal expected load inductance value, which is used as the basis of comparison for future determined load inductance values. The preceding process may repeat continuously and iteratively to compare instantaneous load inductance values over the course of operation with an immediately preceding load inductance value (i.e., the instantaneous load inductance value determined in the preceding cycle of the algorithm) to store and review trends in the instantaneous load inductance over time relative to the baseline expected load inductance value.

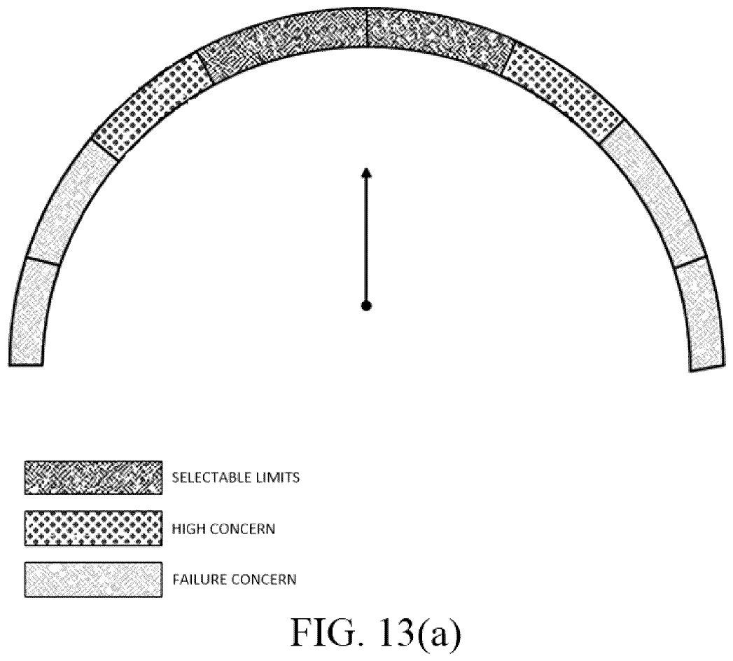

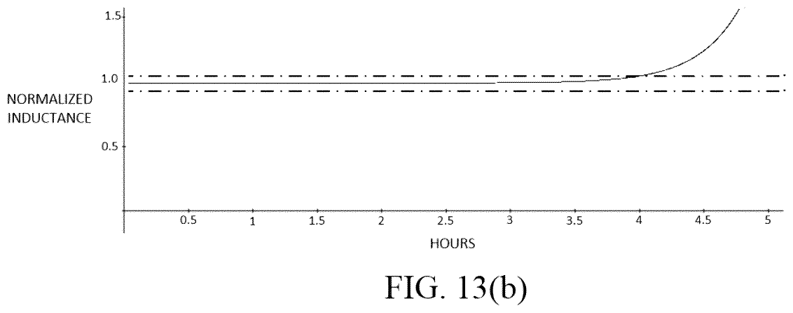

As the instantaneous load inductance value and its deviation from the expected load inductance value is determined, the algorithm may further generate a graphical representation of the deviation 130 over time. The graphical representation may further illustrate one or more defined limits outside of which operation must be halted to address impeder failure or another operational concern, as best illustrated in FIG. 13(b). For example, as the impeder gradually fails, the load inductance deviation from the expected load inductance will increase over time. Once the load inductance deviation exceeds the predefined selectable limits, such as an upper limit exceeding 15% of the expected workpiece load value, a notification may be presented to the operator, either via one of or a combination of the GUI, an SMS message or email as indicated in FIG. 10, an audible alarm associated with the high frequency welding apparatus, or the like. These predefined selectable limits may be process defined, or alternatively, may be further defined by the algorithm to identify the maximum and minimum impedance limits directly corresponding to the particular high frequency welding apparatus and circuit topology. The illustrated limits may further be subdivided into zones of varying degrees of concern. For example, the graphical representation may include a gauge showing an selectable range about the expected workpiece load inductance, a zone of high concern immediately outside of the selectable limits, and a further failure concern zone beyond the zone of high concern. The failure concern zone may represent, for example, either an area representing a high risk of open seam failure in a tube milling operation, or an ongoing open seam failure. These additional zones may further be designated by the operator relative to the expected workpiece load inductance, such as 15-30% above or below the expected workpiece load value representing the high concern zone and above 30% as the failure concern zone. Such maximum and minimum impedance limits may be empirically generated from previously collected and stored operational data, or alternatively analytically determined via circuit analysis. In some embodiments, as best illustrated in FIG. 13(a), a gauge is generated indicating the predefined selectable limits around the expected load value. In the shown embodiment, further warning indicators may be present outside of the predefined selectable limit range to indicate areas of greater operating risk. In the illustrated embodiment, a range of values outside of the selectable limits are designated as operational values of high concern (indicating likely impeder break down) and failure concern (indicating high likelihood of impeder failure in the near future), respectively. These selectable limits, high concern ranges, and failure concern ranges may be manually input by an process or preselected in reference to the particular production run in progress. For example, ideal limit settings (each of the indicated ranges shown in FIG. 13(a)) may be tabulated and stored based on empirical data from prior evaluations of welds as the impeder gradually fails to create a measurable change in load inductance. In such cases, after identifying ideal limit metrics in previous production runs, the same limit metrics can be applied in future production runs for products of various materials and sizes.

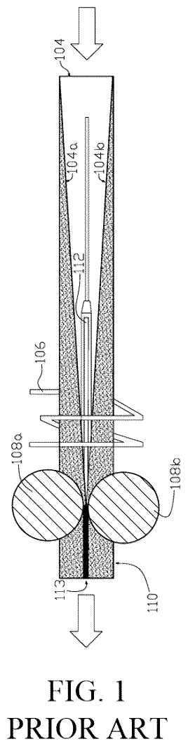

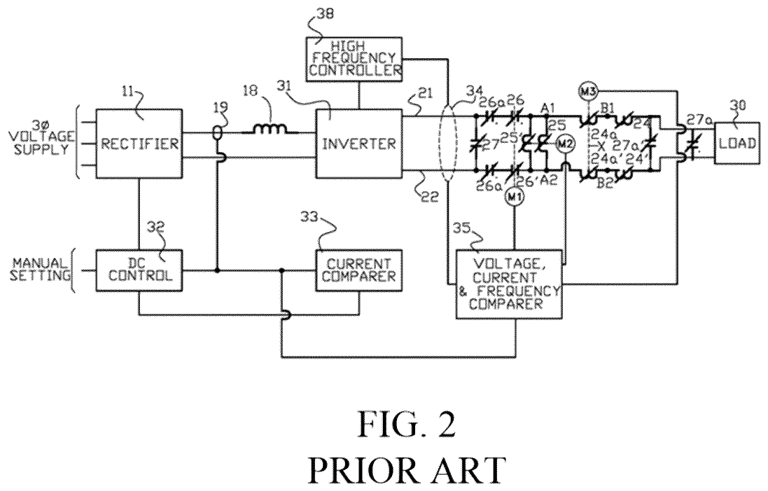

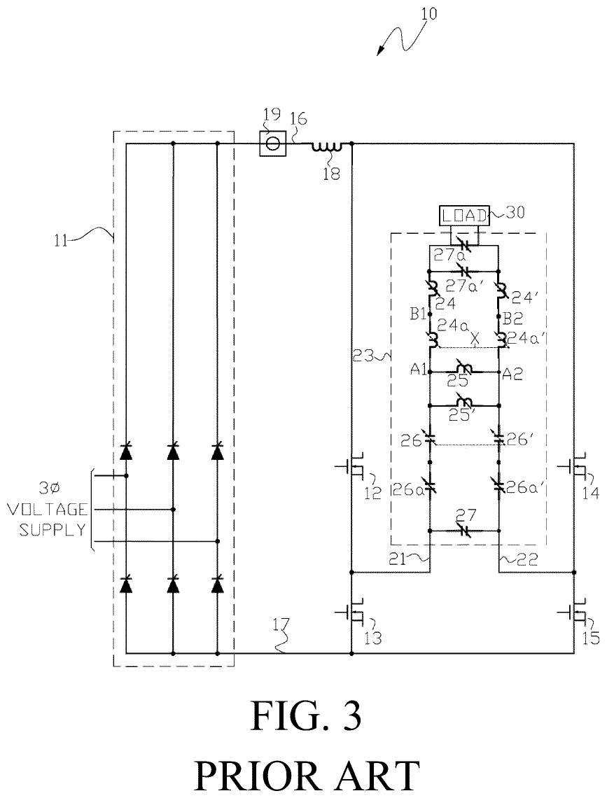

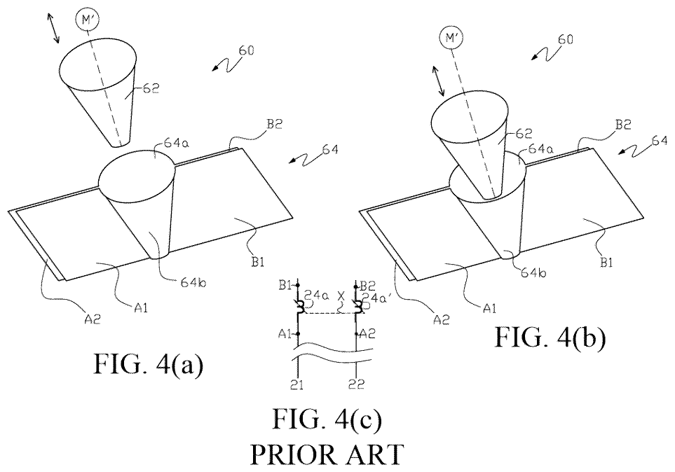

Additionally, as shown in FIG. 12(c), the algorithm may further adjust the power input to the system following a pre-existing model of the inductance relative to an appropriate power level 132. Alternatively, in other embodiments, other process parameters, such as frequency, mill speed, and “vee-length” may be adjusted based on data relating the respective process parameter to the workpiece load inductance. Vee-length refers to the length of the unwelded edges in a tube milling process subject to the induced current, and thereby the inductive heating, caused by an induction coil. As best represented in FIG. 1, opposing edges 104a and 104b form the edges of the vee which are inductively heated by induction coil 106 and rolled together by rollers 108a and 108b to be welded together. The vee-length, that is the effective length over which the induced current travels along the opposing edges 104a and 104b can be adjusted by selectively positioning the induction coil 106 or the impeder 112 to direct the magnetic field to couple with a desired length of the opposing edges 104a and 104b. In such embodiments, the deviation from the expected load inductance is automatically compensated for, while preserving data indicating the deviation over time, ensuring that heat input to the workpiece load is maintained within a process target range until the cause of the deviation is addressed. Finally, the algorithm may further determine a rate of change of the deviation from the expected inductance load value over the course of a production run 134. If the rate of change exceeds a predetermined limit, the operator is alerted via one or more of the previously discussed notification methods, whereupon the system may be disabled to identify and correct the source of the deviation. As long as the rate of change remains above or below the predetermined limits, no alert is generated. In some embodiments, the precise cause of the deviation may further be determined by analysis of direction of the rate of change and the dynamic nature of the deviation, that is that the impedance change occurred over time and not immediately upon system start up. For example, if a difference in load is immediately measured upon startup and remains static over time, the alert may further identify a coil geometry issue, such as the coil being too large, whether that be coil leads being too long, coil diameter being too large, or the coil having too many turns, or alternatively, a rate of change in the deviation may further identify an impeder malfunction or otherwise indicate a gradual failure of the impeder. Alternatively, if the deviation is negative, the coil geometry may have too few turns.

Reference throughout this specification to “one example or embodiment,” “an example or embodiment,” “one or more examples or embodiments,” or “different example or embodiments,” for example, means that a particular feature may be included in the practice of the invention. In the description various features are sometimes grouped together in a single example, embodiment, figure, or description thereof for the purpose of streamlining the disclosure and aiding in the understanding of various inventive aspects.

The present invention has been described in terms of preferred examples and embodiments. Equivalents, alternatives, and modifications, aside from those expressly stated, are possible and within the scope of the invention. Those skilled in the art, having the benefit of the teachings of this specification, may make modifications thereto without departing from the scope of the invention.

1. A high frequency power supply system for heating a workpiece load in an induction heating application having monitored output to provide process feedback, the high frequency power supply system comprising:
an inverter comprising a pair of inverter output leads;
an inverter output impedance adjusting and frequency control network having a control network input connected to the pair of inverter output leads and a control network output connected to the workpiece load, the inverter output impedance adjusting and frequency control network having one or more variable reactors;
wherein the one or more variable reactors are electrically connected to the inverter output leads and the workpiece load, each of the one or more variable reactors producing a variable energy field when electrically energized;
wherein each of the one or more variable reactors comprise a motion stage selectively movable relative to a stationary variable reactor element via one or more motors, each motor of the one or more motors comprising position feedback elements calibrated to report a relative distance between the motion stage and the stationary variable reactor element associated with each motor;
whereupon movement of the motion stage relative to the stationary variable reactor element adjusts the variable energy field and a reactance of the associated variable reactor;
a system microprocessor controller operably connected to each of the one or more variable reactors in the inverter output impedance adjusting and frequency control network to selectively move the motion stage relative to the stationary variable reactor element;
a software processor operably connected to the position feedback elements of each of the one or more motors controlling the motion stage of the one or more variable reactors and the system microprocessor controller;
wherein the software processor determines an effective reactance of each of the one or more variable reactors via the relative distance between the motion stage and the stationary variable reactor element and further applies a load inductance relationship associated with a circuit topography of the inverter output impedance adjusting and frequency control network to determine a current load inductance.

2. The high frequency and power supply system of claim 1, wherein the software processor further normalizes the current load inductance to an initially selected expected workpiece load inductance, defining a deviation from the expected workpiece load inductance.

3. The high frequency and power supply system of claim 1, wherein the effective reactance of each of the one or more variable reactors is determined via one or more methodologies selected from a group consisting of: previously collected empirical data relating the relative distance to a previously measured reactance and electromagnetic modeling.

4. The high frequency and power supply system of claim 2, wherein the software processor further defines one or more limits about the expected workpiece load inductance, the one or more limits defined by one or more of: historically defined empirical limits and analytically defined limit ranges corresponding to the circuit topology.

5. The high frequency and power supply system of claim 1, further comprising a remote asynchronous monitoring processor in communication with the software processor, wherein the asynchronous monitoring processor receives the current load inductance from the software processor over a production run and identifies trends, absolute values, and patterns in the current load inductance via an intelligent network architecture.

6. A high frequency power supply system for heating a workpiece load in an induction heating application having monitored output to provide process feedback, the high frequency power supply system comprising:
a full bridge inverter or a half-bridge inverter comprising a plurality of bridge switching devices and a pair of inverter output leads forming a single-phase inverter output;
an inverter output impedance adjusting and frequency control network having a control network input connected to the pair of inverter output leads and a control network output connected to the workpiece load;
a system microprocessor controller having one or more inverter control outputs to the plurality of bridge switching devices and one or more variable impedance control outputs to one or more variable impedance elements in the inverter output impedance adjusting and frequency control network for an adjustable power transfer from the pair of inverter output leads to the workpiece load and a variable output frequency from the pair of inverter output leads to the workpiece load independent of a workpiece impedance of the workpiece load;
wherein the one or more variable impedance elements comprise:
one or more variable reactors electrically connected to the inverter output leads and the workpiece load, each of the one or more variable reactors producing a variable energy field when electrically energized;
wherein each of the one or more variable reactors comprise a motion stage selectively moveable relative to a stationary variable reactor element via one or more motors, each motor of the one or more motors comprising position feedback elements calibrated to report a relative distance between the motion stage and the stationary variable reactor element associated with each motor;
whereupon movement of the motion stage relative to the stationary variable reactor element adjusts a reactance of the associated variable reactor;
a software processor operably connected to the position feedback elements of each of the one or more motors controlling the motion stage of the one or more variable reactors and the system microprocessor controller, wherein the software processor identifies a current workpiece load inductance value by performing the steps:
(a) defining a load inductance relationship corresponding to a circuit topology of the inverter output impedance adjusting and frequency control network, the load inductance relationship corresponding to one or more known reactances and an operating frequency;
(b) receiving the relative distance between the motion stage and the stationary variable reactor element of each of the one or more variable reactors from the position feedback elements;
(c) receiving a current operating frequency from the system microprocessor controller;
(d) determining an effective reactance of each of the one or more variable reactors via the relative distance;
(e) applying the load inductance relationship to determine a current load inductance using the effective reactance of each of the one or more variable reactors and the current operating frequency.

7. The high frequency power supply system of claim 6, further comprising the step of defining one or more limits about an expected workpiece load inductance.

8. The high frequency power supply system of claim 7, further comprising the steps of:
generating a graphical representation of a deviation from the expected workpiece load inductance over time as a result of each determined current load inductance over a course of an operation time; and
displaying the graphical representation on a user interface operably connected to the software processor.

9. The high frequency power supply system of claim 8, wherein the graphical representation further includes boundaries associated with the one or more limits defined around the expected workpiece load inductance.

10. The high frequency power supply system of claim 6, further comprising the step of applying a curve fit to previously collected empirical data relating the relative distance to a measured reactance to interpolate the effective reactance of each of the one or more variable reactors outside of a scope of the previously collected empirical data.

11. The high frequency power supply system of claim 6, wherein the effective reactance of each of the one or more variable reactors is determined via electromagnetic modeling of the high frequency power supply system.

12. The high frequency power supply system of claim 7, further comprising the step of determining a magnitude and a direction of a rate of change in a deviation of the current load inductance from the expected load inductance.

13. The high frequency power supply system of claim 12, further comprising the step of extrapolating a predicted time until the deviation will exceed the one or more limits.

14. The high frequency power supply system of claim 12, further comprising the step of generating an alert when the magnitude of the rate of change exceeds a threshold limit.

15. The high frequency power supply system of claim 12, further comprising the steps of:
determining a source of the deviation from the expected workpiece load inductance based on the direction of the rate of change in the deviation; and
generating a diagnostic report identifying a source of the deviation from the expected workpiece load, wherein the source is selected from a group consisting of: improper coil geometry, improper coil installation, and impeder failure.

16. The high frequency power supply system of claim 6, further comprising the step of adjusting one or more process parameters of the high frequency power supply system corresponding to a pre-existing model of a deviation of the current load inductance from one of an expected load inductance and an initial load inductance relative to an associated process parameter, wherein the one or more process parameters are selected from a group consisting of: a power level, a frequency, and a vee-length of the workpiece load.

17. The high frequency power supply system of claim 6, wherein the motion stage of each of the one or more variable reactors is operably connected to a lead screw actuatable by an associated motor of the one or more motors, such that when the lead screw is actuated, a position of the associated motion stage is adjusted, wherein the motion stage is selected from a group consisting of a ferrite core and a coil.

18. The high frequency power supply system of claim 6, wherein the motion stage of each one of the one or more variable reactors comprises a geometrically-shaped moveable insert core and the stationary variable reactor element comprises a split-bus comprising:
a geometrically-shaped split bus section having a geometric complementary shape to the geometrically-shaped moveable insert core to provide an adjustable position of insertion of the geometrically-shaped moveable insert core into the geometrically-shaped split bus section to vary a reactance of the one or more variable reactors from a minimum reactance value when the geometrically-shaped moveable insert core is fully inserted into the geometrically-shaped split bus section to a maximum reactance value when withdrawn from the geometrically-shaped split bus section to a position where a variable energy field in a shaped interleaving space between the geometrically-shaped moveable insert core and the geometrically-shaped split bus section is at a maximum value; and
a split electric bus terminal section for an electrical connection of each of the one or more variable reactors in the inverter output impedance adjusting and frequency control network.

19. The high frequency power supply system of claim 6, further comprising the step of transmitting one or more of the current load inductance and a deviation of the current load inductance from an expected workpiece load inductance to a remote non-transitory computer readable memory storage in communication with an asynchronous monitoring processor, wherein the asynchronous monitoring processor identifies trends in the current load inductance and the deviation from the expected workpiece load inductance and is further operably connected to an asynchronous monitoring storage accessible by an online platform.

20. The high frequency power supply system of claim 19, further comprising generating an alert upon detection of the identified trends exceeding a defined limit indicative of an actionable maintenance event, wherein the alert is selected from a group consisting of: an email, an SMS notification, a website notification, and a push notification.

21. The high frequency power supply system of claim 20, wherein the asynchronous monitoring processor includes an intelligent network architecture implementing a diagnosis algorithm trained from previously collected trend data to diagnose one or more actionable maintenance events associated with the identified trends in the current load inductance and the deviation from the expected workpiece load inductance.

22. A method for continuously monitoring a current load inductance and providing process feedback in a high frequency power supply system for heating a workpiece load in an induction heating application over an operation time, the high frequency power supply system having an inverter output impedance adjusting and frequency control network having one or more variable reactors, the method comprising the steps of:
(a) defining a load inductance relationship corresponding to a circuit topology of the inverter output impedance adjusting and frequency control network, the load inductance relationship corresponding to one or more known reactances and an operating frequency;
(b) identifying a relative distance between a motion stage of each of the one or more variable reactors and a stationary variable reactor element of each of the one or more variable reactors, each motion stage selectively moveable relative to each stationary variable reactor element via a motor having a position feedback element, wherein the relative distance is reported by the position feedback element of the associated motor;
(c) receiving a current operating frequency from a system microprocessor controller of the inverter output impedance adjusting and frequency control network, the system microprocessor maintaining the current operating frequency at an instantaneous resonant frequency of a workpiece load circuit via a phase-locked-loop;
(d) determining an effective reactance of each of the one or more variable reactors via previously collected empirical data relating the relative distance to a previously measured reactance;
(e) applying the load inductance relationship to determine a current load inductance using the effective reactance of each of the one or more variable reactors and the current operating frequency.

23. The method of claim 22, further comprising the steps of:
initially selecting an expected workpiece load inductance for a defined production run based on empirical or analytical data from a database of compiled workpiece load induction values; and
defining one or more limits about the expected workpiece load inductance.

24. The method of claim 23, further comprising the step of normalizing the current load inductance to the expected workpiece load inductance, defining a deviation from the expected workpiece load inductance.

25. The method of claim 24, further comprising the step of generating a graphical representation of the deviation from the expected workpiece load inductance as a result of each determined current load inductance over the course of the operation time, wherein the graphical representation includes boundaries associated with the one or more limits defined around the expected workpiece load inductance.

26. The method of claim 22, further comprising the step of registering a workpiece load inductance with the database of compiled workpiece load inductance values, wherein the workpiece load inductance comprises a steady state operating inductance value for the defined production run.

27. The method of claim 24, further comprising the step of transmitting the current load inductance and the deviation from the expected workpiece load inductance to a remote non-transitory computer readable memory storage in communication with an asynchronous monitoring processor.

28. The method of claim 27, wherein the asynchronous monitoring processor performs the steps of:
identifying trends in the current load inductance and the deviation from the expected workpiece load inductance;
providing an alert to upon detection of the identified trends exceeding a defined limit indicative of an actionable maintenance event.

29. The method of claim 23, further comprising the step of applying a curve fit to the previously collected empirical data to interpolate the effective reactance of each of the one or more variable reactors outside of a scope of the previously collected empirical data.

30. The method of claim 24, further comprising the steps of:
determining a magnitude and a direction of a rate of change in the deviation from the expected workpiece load inductance; and
generating an alert when the magnitude of the rate of change exceeds a threshold limit.

31. The method of claim 30, further comprising the step of extrapolating a predicted time until the deviation will exceed at least one of the one or more limits.

32. The method of claim 30, further comprising the steps of:
determining a source of the deviation from the expected workpiece load inductance based on the direction of the rate of change in the deviation; and
generating a diagnostic report identifying the source of the deviation from the expected workpiece load inductance, wherein the source is selected from a group consisting of:
improper coil geometry, improper coil installation, and impeder failure.

33. The method of claim 25, further comprising the step of displaying the graphical representation of the deviation from the expected workpiece load inductance on one or more of a graphical user interface and an online platform.
